(19) United States
(12) Patent Application Publication
(10) Pub. No.: US 2025/0201217 A1
(43) Pub. Date: Jun. 19, 2025

(54) MULTI-MODAL BASED AUTOMATIC MUSIC GENERATION METHOD AND DEVICE

(71) Applicant: Neutune Co.,Ltd., Seoul (KR)

(72) Inventors: Jong Pil LEE, Seoul (KR); Sang Eun KUM, Seoul (KR); Tae Hyoung KIM, Seoul (KR); Keun Hyoung KIM, Seoul (KR)

(73) Assignee: Neutune Co.,Ltd., Seoul (KR)

(21) Appl. No.: 18/593,239

(22) Filed: Mar. 1, 2024

(30) Foreign Application Priority Data
Dec. 13, 2023 (KR) 10-2023-0180783

(51) Int. Cl. G10H 1/00

(52) U.S. Cl. CPC G10H 1/0025; G10H 2210/111; G10H 2220/441; G10H 2240/131

(57) ABSTRACT

A multi-modal based automatic music generation device according to an embodiment of present invention comprises an embedding extraction module configured to generate an input embedding vector from input information received from a user terminal, a stem search module configured to select a reference stem based on the input embedding vector and select a plurality of similar stems based on the input embedding vector and an embedding vector included in the reference stem, a reference section generation module configured to create a reference section by editing and mixing the plurality of similar stems and a music generation module configured to generate music in song units by generating a plurality of audio sections based on the reference section.

### CROSS-REFERENCE TO RELATED APPLICATIONS

This application claims priority to Korean Patent Application No. 10-2023-0180783 filed Dec. 13, 2023, the entire disclosure of which is incorporated herein by reference.

### TECHNICAL FIELD

The present invention relates to a method and device for automatically generating multi-modal music. More specifically, the present invention relates to an automatic music generation method and device that automatically generates song-level music using multi-modal information such as text, images, videos, and reference music information input from the user.

### BACKGROUND ART

With the advancement of technology, it has become possible to digitize existing large-capacity media and convert it into low-capacity media. Today, users can store various types of media in portable user terminal devices and easily select and enjoy the media they want on the go.

In addition, media digitized through digital compression technology is explosively revitalizing online media services by enabling media sharing between users on a network, and many applications or programs related to this are being developed.

Among this vast number of media available, music accounts for a significant portion.

Compared to other media types, music has a low capacity and low communication load, making it easy to support real-time streaming services, resulting in high satisfaction for both service providers and users.

Accordingly, services that provide online music to users in various ways are currently emerging.

Existing online music services simply provide music in real time to users connected online, such as by providing music to the user's terminal device or providing streaming services.

However, recently, services are being provided that recommend highly preferred media to users by utilizing big data or artificial intelligence technology.

However, in the case of existing online music services, there is a problem that they only recommend existing music like the music preferred by the user but cannot create new music that did not exist before and provide it to the user.

Additionally, in the case of existing online music services, text information is input from the user and music is recommended based on it, so there is a problem in that various types of user commands cannot be received.

### PRIOR ART DOCUMENT

### Patent Document

(Patent Document 1) Korean Patent Publication No. 10-2015-0084133 (published on Jul. 22, 2015-‘Pitch recognition using sound interference phenomenon and scale notation method using the same’)
(Patent Document 2) Korean Patent No. 10-1696555 (2019.06.05.)—‘Text location search system and method through voice recognition in image or geographic information’

### DISCLOSURE

### Technical Problem

Accordingly, the multi-modal-based automatic music generation method and device according to the disclosed invention are inventions created to solve the above-mentioned problems.

More specifically, the present invention can provide an automatic music generation method and device that generates various types of input embedding vectors from input information including text information, image information, music information, and video information from the user, and based on this, combines a plurality of stems from the audio database to unite the song.

In addition, the method and device for automatically generating multi-modal music according to the disclosed invention can provide a method and device for automatically generating music that generates more natural and complete music by selecting a reference stem from an audio database based on an input embedding vector and then selecting a similar stem through the process.

### Technical Solution

A multi-modal based automatic music generation device according to an embodiment of present invention comprises an embedding extraction module configured to generate an input embedding vector from input information received from a user terminal, a stem search module configured to select a reference stem based on the input embedding vector and select a plurality of similar stems based on the input embedding vector and an embedding vector included in the reference stem, a reference section generation module configured to create a reference section by editing and mixing the plurality of similar stems and a music generation module configured to generate music in song units by generating a plurality of audio sections based on the reference section.

wherein the input information includes at least one of text information, image information, music information, and video information.

The multi-modal based automatic music generation device further comprises an image captioning module that converts the image information into text and outputs it as image text information, a video captioning module that converts the video information into text and outputs it as video text information and a music captioning module that converts the music information into text and outputs it as music text information.

wherein the embedding extraction module comprises a text embedding extraction module configured to generate a text embedding vector from the input text information, the image text information, the video text information, and the music text information.

wherein the embedding vector included in the reference stem includes at least one of beat, tonality, and tempo information.

A multi-modal based automatic music generation method according to an embodiment of present invention comprises a step of generating an input embedding vector from input information received from a user terminal a step of selecting a reference stem based on the input embedding vector and selecting a plurality of similar stems based on the input embedding vector and embedding vectors included in the reference stem, a step of generating a reference section by editing and mixing the plurality of similar stems and a step of generating music in song units by creating a plurality of audio sections based on the reference section.

wherein the input information includes at least one of text information, image information, music information, and video information.

### Advantageous Effects

Therefore, the multi-modal-based automatic music generation method and device according to the disclosed invention can generate various types of input embedding vectors from input information including text information, image information, music information, and video information from the user.

Additionally, the present invention has the advantage of being able to generate song-level music by combining a plurality of stems from an audio database based on this.

In addition, the method and device for automatically generating multi-modal music according to the disclosed invention have advantages to generate more natural and complete music by selecting a reference stem from an audio database based on an input embedding vector and then selecting a similar stem through the process.

In addition, the multi-modal-based music automatic generation method and device according to the disclosed invention have advantages to automatically generate music in a completed song unit that reflects the text, image, and atmosphere of the music input from the user, and updates it in the database so that the user can be able to continuously create and listen to sound sources of different styles.

### BRIEF DESCRIPTION OF DRAWINGS

FIG. 1 is a diagram showing a multi-modal-based automatic music generation system according to an embodiment of the disclosed invention.

FIG. 2 is a diagram showing the configuration of a multi-modal-based automatic music generation device according to an embodiment of the disclosed invention.

FIG. 3 is a diagram showing the configuration of a text conversion module in a multi-modal-based automatic music generation device according to an embodiment of the disclosed invention.

FIG. 4 is a diagram showing the configuration of an embedding extraction module in a multi-modal-based automatic music generation device according to an embodiment of the disclosed invention.

FIG. 5 is a diagram showing the configuration of a stem search module in a multi-modal-based automatic music generation device according to an embodiment of the disclosed invention.

FIG. 6 is a diagram illustrating the overall process of a multi-modal-based automatic music generation method and device according to an embodiment of the disclosed invention.

FIG. 7 is a diagram illustrating a process in which a multi-modal-based automatic music generation device according to an embodiment of the disclosed invention generates a stem-based reference section and generates music in song units.

FIG. 8 is a diagram illustrating a process in which an input embedding vector is generated by inputting text information, image information, video information, and reference music information into a multi-modal-based automatic music generation device according to an embodiment of the disclosed invention.

FIG. 9 is a diagram illustrating the process of generating a reference stem, a similar stem, and a reference section using the input embedding vector shown in FIG. 8.

FIG. 10 is a diagram illustrating a process of selecting a reference stem in a multi-modal-based automatic music generation device according to an embodiment of the disclosed invention.

FIG. 11 is a diagram illustrating a process of filtering a database based on a reference stem in a multi-modal-based automatic music generation device according to an embodiment of the disclosed invention.

FIG. 12 is a diagram illustrating a process of selecting a similar stem from a filtered database in a multi-modal-based automatic music generation device according to an embodiment of the disclosed invention.

FIG. 13 is a diagram illustrating a process of generating a reference section by editing and mixing selected similar stems in a multi-modal-based automatic music generation device according to an embodiment of the disclosed invention.

FIG. 14 is a diagram illustrating a process of generating music in song units based on a reference section in a multi-modal-based automatic music generation device according to an embodiment of the disclosed invention.

FIG. 15 is a flow chart illustrating a multi-modal-based automatic music generation method according to an embodiment of the disclosed invention.

### MODES OF THE INVENTION

The embodiments described in this specification and the configurations shown in the drawings are only preferred examples of the disclosed invention, and at the time of filing this application, there may be various modifications that can replace the embodiments and drawings in this specification.

In addition, the same reference numbers or symbols shown in each drawing of this specification indicate parts or components that perform substantially the same function.

Additionally, the terms used herein are used to describe embodiments and are not intended to limit and/or limit the disclosed invention. Singular expressions include plural expressions unless the context clearly dictates otherwise.

In this specification, terms such as “comprise” or “have” are intended to indicate the presence of features, numbers, steps, operations, components, parts, or combinations thereof described in the specification, but are not intended to indicate the presence of one or more other features. The existence or addition of numbers, steps, operations, components, parts, or combinations thereof is not excluded in advance.

In addition, terms including ordinal numbers such as “first”, “second”, etc. used in this specification may be used to describe various components, but the components are not limited by the terms, and the terms used only for the purpose of distinguishing one component from another.

For example, a first component may be named a second component, and similarly, the second component may also be named a first component without departing from the scope of the present invention. The term “and/or” includes any combination of a plurality of related stated items or any of a plurality of related stated items.

Hereinafter, embodiments according to the present invention will be described in detail with reference to the attached drawings.

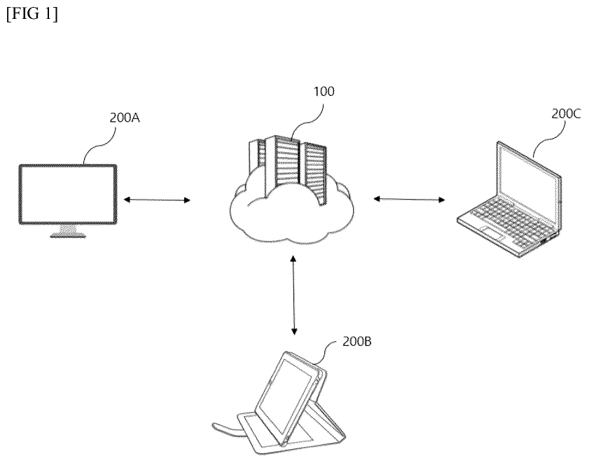

FIG. 1 is a diagram showing a multi-modal-based automatic music generation system according to an embodiment of the disclosed invention.

Referring to FIG. 1, the multi-modal-based automatic music generation system according to an embodiment of the disclosed invention may include an automatic music generation device that automatically generates music in song units by transmitting and receiving information with user terminals 200A, 200B, 200C and user terminals 200A, 200B, and 200C that transmit various types of input information to 100 and the automatic music generation device 100.

As shown in the figure, the user terminals 200A, 200B, and 200C may include a plurality of user terminals 200A, 200B, and 200C.

The automatic music generation device 100 according to the disclosed invention can generate and play music with a similar feeling based on input information input by the user through the user terminals 200A, 200B, and 200C.

Specific details regarding this will be described later.

The automatic music generation device 100 according to the disclosed invention can be implemented as a server that receives input information from the user terminals 200A, 200B, and 200C, generates music in song units based on the input information, and transmits it to the user terminals 200A, 200B, and 200C.

In the present invention, a server refers to a typical server. A server is computer hardware on which a program is running, and monitors or controls the entire network, such as printer control or file management, or other functions through a main frame or public network. It can support the sharing of software resources such as network connections, data, programs, and files, or hardware resources such as modems, faxes, shared printers, and other equipment.

The user terminals 200A, 200B, 200C use a specific program or application installed on the user terminals 200A, 200B, 200C to provide the audio generation and audio playback services provided by the automatic music generation device 100 to the user terminal 200A, 200B, 200C can be displayed on the display.

Meanwhile, in FIG. 1, the automatic music generation device 100 is implemented as a server and is described based on receiving an interface through which a user can input information from the server.

However, the embodiment of the present invention is not limited to the fact that the automatic music generation device 100 according to the present invention is implemented as a server.

For example, the automatic music generation device 100 may be implemented with user terminals 200A, 200B, and 200C.

When the automatic music generation device 100 is implemented as a user terminal 200A, 200B, 200C, the control unit included in the user terminal 200A, 200B, 200C directly generates an audio generation interface screen, and the generated interface screen may be displayed on the display of the user terminal 200A, 200B, 200C.

Specifically, the user terminals 200A, 200B, and 200C include a control unit capable of generating an interface screen provided by the automatic music generation device 100.

This control unit can generate a mixing audio generation interface screen and provide the generated screen to the user through the display of the user terminal 200A, 200B, 200C.

Accordingly, the user can input at least one of text information, image information, music information, and video information through the audio mixing interface screen and transmit it to the automatic music generation device 100.

Accordingly, the user terminals 200A, 200B, and 200C may be implemented as multiple terminal devices including a control unit so that these algorithms can be realized.

For example, the user terminals 200A, 200B, and 200C may be implemented as a personal computer (PC) 200A, a smart pad 200B, or a notebook 200C, as shown in FIG. 1.

In addition, although not shown in the drawing, user terminals (200A, 200B, 200C) include a PDA (Personal Digital Assistant) terminal, Wibro (Wireless Broadband Internet) terminal, smartphone, tablet PC, smart watch, and it can be implemented with all types of handheld wireless communication devices, such as smart glass and wearable devices.

Additionally, the automatic music generation device 100 according to the disclosed invention may correspond to a computing device that transmits and receives data to and from a server using a network and can execute various software.

Here, the network refers to a connection structure that allows information exchange between each node, such as a plurality of terminals and servers. Examples of such networks include a local area network (LAN) and a wide area network (WAN). Wide Area Network, Internet (WWW: World Wide Web), wired and wireless data communication network, telephone network, wired and wireless television communication network, etc.

Examples of wireless data communication networks include 3G, 4G, 5G, 3rd Generation Partnership Project (3GPP), 5th Generation Partnership Project (5GPP), Long Term Evolution (LTE), World Interoperability for Microwave Access (WIMAX), Wi-Fi, Internet, LAN (Local Area Network), Wireless LAN (Wireless Local Area Network), WAN (Wide Area Network), PAN (Personal Area Network), RF (Radio Frequency), Bluetooth network, NFC (Near)-Field Communication) network, satellite broadcasting network, analog broadcasting network, DMB (Digital Multimedia Broadcasting) network, etc., but is not limited thereto.

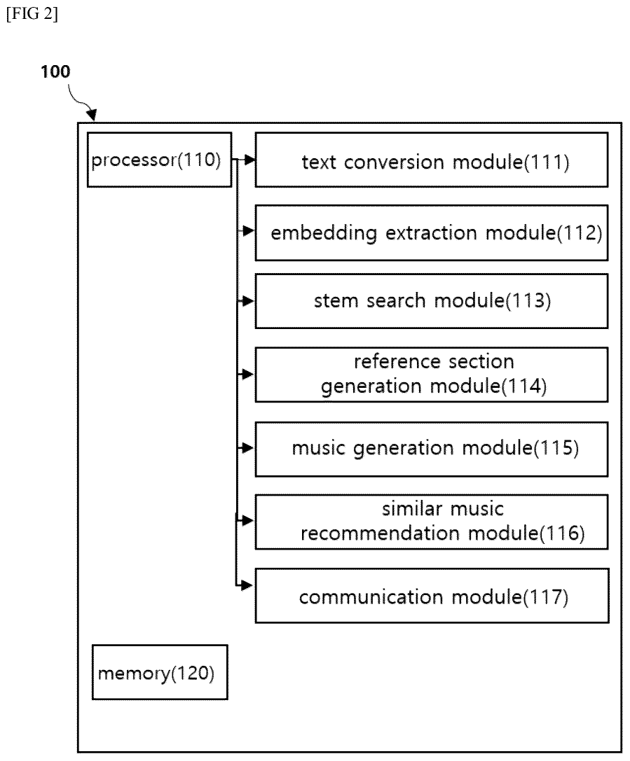

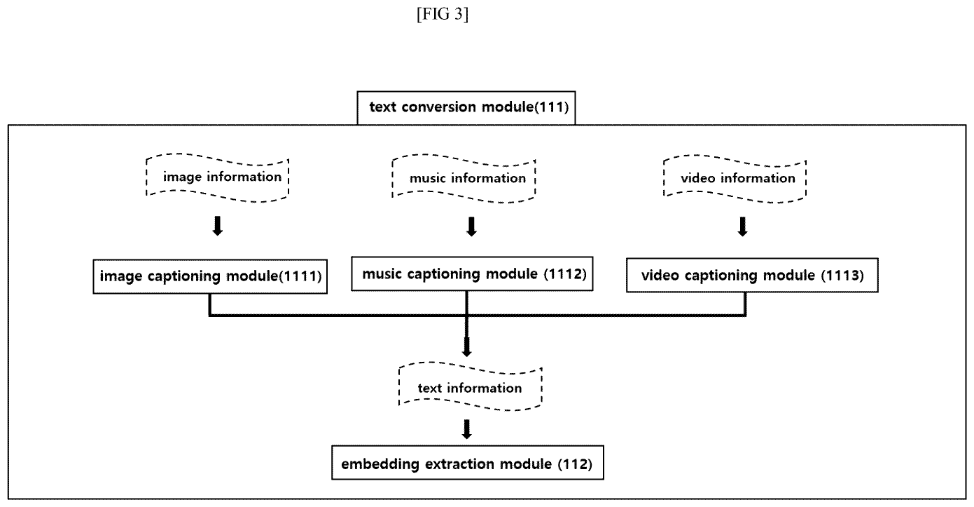

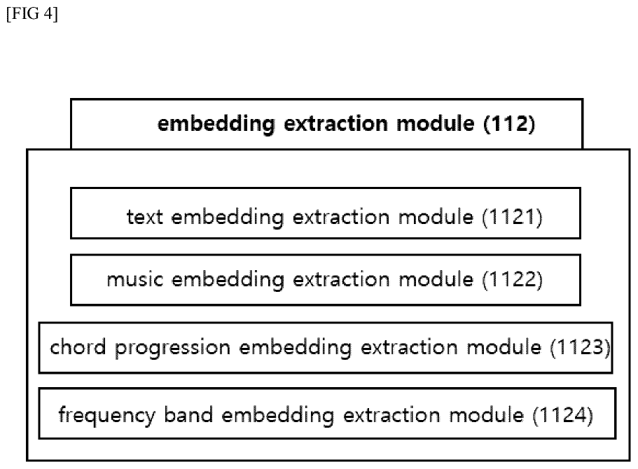

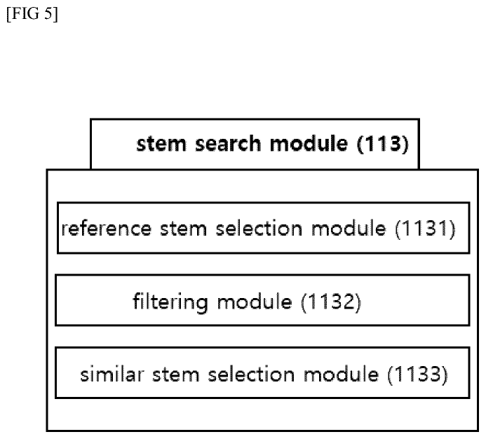

FIG. 2 is a diagram showing the configuration of a multi-modal-based automatic music generation device according to an embodiment of the disclosed invention. FIG. 3 is a diagram showing the configuration of a text conversion module in a multi-modal-based automatic music generation device according to an embodiment of the disclosed invention. FIG. 4 is a diagram showing the configuration of an embedding extraction module in a multi-modal-based automatic music generation device according to an embodiment of the disclosed invention. FIG. 5 is a diagram showing the configuration of a stem search module in a multi-modal-based automatic music generation device according to an embodiment of the disclosed invention.

Referring to FIG. 2, the automatic music generation device 100 according to an embodiment of the disclosed invention may include a processor 110 and a memory 120.

More specifically, the processor 110 converts and processes information into data, and the memory 120 may be configured to store the information processed by the processor 110 and derived information.

The processor 110 and memory 120 may be implemented as at least one of a storage medium that stores programs and data required for the operations described above in FIG. 1, and the processor 110 and memory 120 may be implemented as a single chip or a separate chip.

In addition, the processor 110 of the automatic music generation device 100 according to the disclosed invention includes a text conversion module 111, an embedding extraction module 112, a stem search module 113, a reference section generation module 114, and a music generation module 115, a similar music recommendation module 116, and a communication module 117.

Referring to FIGS. 2 and 3, the text conversion module 111 according to the disclosed invention may include an image captioning module 1111 that converts image information input to the user terminals 200A, 200B, and 200C into a sentence containing text and outputs the image as image text information.

In addition, the text conversion module 111 according to the disclosed invention includes a music captioning module 1112 that converts music information input to the user terminals 200A, 200B, and 200C into sentences containing text and outputs them as music text information.

In addition, the text conversion module 111 according to the disclosed invention includes a video captioning module 1113 that converts video information input to the user terminals 200A, 200B, and 200C into sentences containing text and outputs them as video text information.

More specifically, the automatic music generation device 100 according to the disclosed invention may receive input information through a user terminal.

Specifically, input information may include at least one of text information, image information, music information, and video information.

The input text information may be input to the text embedding extraction module 112, which will be described later, and output as a text embedding vector.

Additionally, the embedding extraction module 112 can extract individual music information such as instrument, genre, and mood from the input text information, and use the extracted music information for searching and selecting sound sources and composing songs.

For example, if the input text information includes the length of the song (e.g., 30 seconds, 1 minute and 30 seconds of music), tempo (slow, normal, fast), instrument (e.g., piano solo song, music with a guitar played), related to genre and mood, the embedding extraction module 1121 can separately extract this information and reflect it in searching and selecting sound sources and composing songs.

Additionally, the image information, video information, and music information can be converted into sentences including text through the text conversion module 111 and output as image text information, video text information, and music text information, respectively.

Additionally, the output image text information, video text information, and music text information may be input to the embedding extraction module 112 and output as a text embedding vector.

Accordingly, the disclosed invention utilizes the image captioning module 1111, the music captioning module 1112, and the video captioning module 1113 to receive various types of input information from the user and determine the mood and genre of music desired by the user. There is a technical effect that can create mixed music by understanding the feeling, etc. in more detail.

However, the input information input to the user terminals 200A, 200B, and 200C is not limited to this, and the input information may include at least one of date information, weather information, and location information included in the image captured by the user.

Accordingly, the automatic music generation device 100 according to the disclosed invention can receive information generated based on the user environment, such as date information, weather information, and location information, and generate music that matches the input.

Referring to FIGS. 2 and 4, the embedding extraction module 112 according to the disclosed invention includes a text embedding extraction module 1121, a music embedding extraction module 1122, a chord progression embedding extraction module 1123, and a frequency band embedding extraction module. (1124).

The embedding extraction module 112 may be configured to generate an input embedding vector from input information received from the user terminals 200A, 200B, and 200C.

More specifically, the text embedding extraction module 1121 of the embedding extraction module 112 converts the input text information, image information, video information, and music information and generates a text embedding vector from the output image text information, video text information, and music text information.

In addition, the music embedding extraction module 1122 of the embedding extraction module 112 extracts and generates a music embedding vector including the genre, mood, tempo, and instrument information of the music from the music information received from the user terminals 200A, 200B, and 200C.

In addition, the chord progression embedding extraction module 1123 of the embedding extraction module 112 extracts and generates a chord progression embedding vector including chord progression information of the music from the music information received from the user terminals 200A, 200B, and 200C.

More specifically, the chord progression embedding extraction module 1123 extracts CHROMA from audio information included in music information, encodes and decodes it, and generates a chord progression embedding vector.

At this time, the encoded information may also include information according to time.

In addition, the frequency band embedding extraction module 1124 of the embedding extraction module 112 analyzes the spectrum of the corresponding music from the music information received from the user terminals 200A, 200B, and 200C to generate a frequency band embedding vector containing the frequency band information.

More specifically, the frequency band embedding extraction module 1124 analyzes the spectrum over 6 octaves in 1 semitone units from music information, calculates the average value over the entire time, and extracts and generates the frequency band embedding vector.

At this time, the generated frequency band embedding vector may include low stem information, mid stem information, and high stem information of the input music.

Accordingly, the disclosed invention can generate a reference section including a plurality of similar stems whose respective frequencies do not overlap, based on the frequency band embedding vector generated by the frequency band embedding extraction module 1124.

Detailed information regarding this will be described later.

Therefore, the input embedding vector is a text embedding vector output by the text embedding extraction module 1121, a music embedding vector output by the music embedding extraction module 1122, and a chord progression embedding vector output by the chord progression embedding extraction module 1123 and a frequency band embedding vector output by the frequency band embedding extraction module 1124.

Referring to FIGS. 2 and 5, the stem search module 113 according to the disclosed invention may include a reference stem selection module 1131, a filtering module 1132, and a similar stem selection module 1133.

Specifically, the stem search module 113 may be configured to select a reference stem based on an input embedding vector and select a plurality of similar stems based on the input embedding vector and an embedding vector included in the reference stem.

More specifically, the reference stem selection module 1131 of the stem search module 113 can search and select a reference stem in the database based on the text embedding vector and the music embedding vector.

At this time, the reference stems can be selected with the highest similarity by judging the similarity between text embedding vectors and music embedding vectors generated based on input information input to the user terminals 200A, 200B, and 200C, and text embedding vectors and music embedding vectors of a plurality of stems included in the database.

Additionally, the reference stem may include an embedding vector including beat, key, tempo, chord progression, and frequency band information.

Details regarding these reference systems are described later.

Additionally, the filtering module 1132 of the stem search module 113 may extract a similarity search database for selecting a similar stem from the database based on the embedding vector included in the reference stem.

More specifically, the filtering module 1132 filters only similar stems based on an embedding vector containing the beat, tonality, and tempo information of the reference stem, determines the similarity with the input embedding vector based only on the filtered database to determine the reference stem and selects multiple similar stems to make up a reference section.

Detailed information regarding this will be described later.

In addition, the similar stem selection module 1133 of the stem search module 113 determines the similarity between the embedding vectors of each of the plurality of stems included in the database filtered by the filtering module 1132 and the input embedding vector generated from input information and selects a similar stem.

Additionally, the similar stem selection module 1133 of the stem search module 113 may select a similar stem based on the chord progression embedding vector and frequency band embedding vector included in the reference stem.

Detailed information regarding this will be described later.

Referring to FIG. 2, the reference section creation module 114 according to the disclosed invention may be configured to create a reference section by editing and mixing a plurality of selected similar stems.

More specifically, when a similar stem is selected by the similar stem selection module 1133 of the stem search module 113, the reference section creation module 114 edits the location, beat, length, etc. of the selected similar stems and create a reference section by mixing them.

Additionally, the music generation module 115 according to the disclosed invention may be configured to generate music in song units by generating a plurality of audio sections based on the generated reference section.

More specifically, based on the reference stem included in the reference section, the music generation module 115 arranges stems with the same properties as the reference stem within a plurality of audio sections in the order of progression of the original sound source stem including the reference stem. It can be designated as a reference stem for each audio section.

In addition, based on the reference stem included in the reference section, the music generation module 115 can take stems with the same properties as the reference stem within a plurality of audio sections as the reference stem for each audio section regardless of the stem progression order of the original sound source including the reference stem by arranging the stems freely.

Additionally, if the text information input by the user includes song length information, the music generation module 115 may configure the audio section by reflecting this.

For example, when text information such as ‘Make 1 minute and 30 seconds of exciting music’ is input from the user, the music generation module 115 may configure the audio section by reflecting the song length information of 1 minute and 30 seconds.

Additionally, the music generation module 115 may determine the similarity based on the reference stem for each audio section and select a stem with properties other than the reference stem, thereby generating a plurality of audio sections.

Additionally, the similar music recommendation module 116 according to the disclosed invention may be configured to extract a music embedding vector from the music of the final generated song unit.

More specifically, the similar music recommendation module 116 may output music to be played next to the final generated music using the music embedding vector of the final generated music as an input value.

Therefore, the disclosed invention has the technical effect of being able to infinitely generate music with a similar feel to the music of the final generated song unit without new input values.

The communication module 117 according to the disclosed invention may be configured to communicate with the automatic music generation device 100 and an external server.

More specifically, a plurality of devices can transmit and receive information between each other through the communication module 117, and the communication module 117 includes, for example, at least one of a short-range communication module, a wired communication module, and a wireless communication module.

The short-range communication module transmits signals using a wireless communication network at a short distance, such as a Bluetooth module, infrared communication module, RFID (Radio Frequency Identification) communication module, WLAN (Wireless Local Access Network) communication module, NFC communication module, and Zigbee communication module. It may include various short-range communication modules that transmit and receive.

Wired communication modules include various wired communication modules such as Local Area Network (LAN) modules, Wide Area Network (WAN) modules, or Value-Added Network (VAN) modules, as well as USB (Universal Serial Bus) modules. It may include various cable communication modules such as High-Definition Multimedia Interface (HDMI),
Digital Visual Interface (DVI), recommended standard 232 (RS-232), power line communication, or plain old telephone service (POTS).

In addition to Wi-Fi modules and WiBro (Wireless broadband) modules, wireless communication modules include GSM (global System for Mobile Communication), CDMA (Chord Division Multiple Access), WCDMA (Wideband Chord Division Multiple Access), UMTS (universal mobile telecommunications system), TDMA (Time Division Multiple Access), and LTE (Long Term Evolution). It may include a wireless communication module that supports various wireless communication methods.

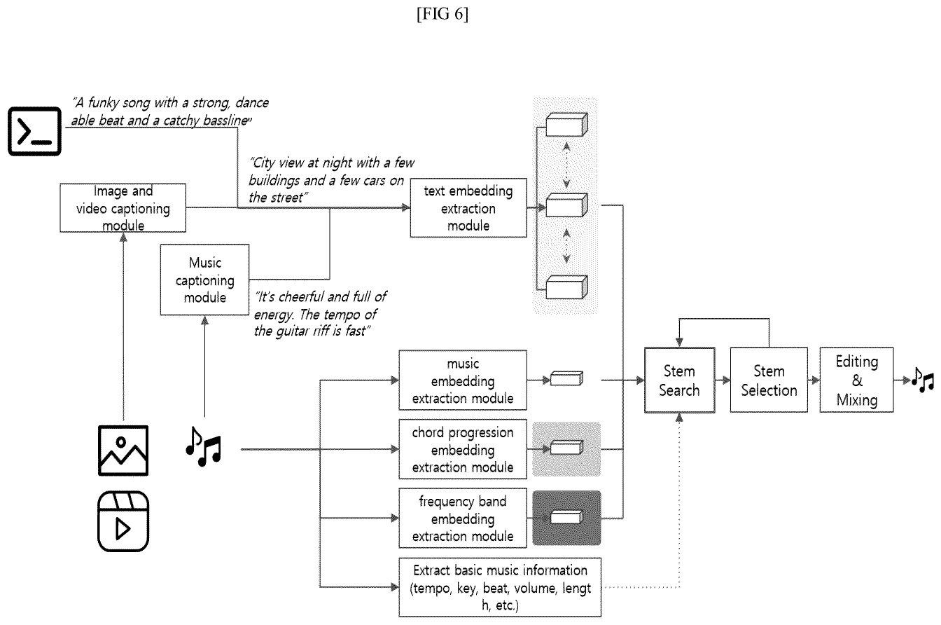

FIG. 6 is a diagram illustrating the overall process of a multi-modal-based automatic music generation method and device according to an embodiment of the disclosed invention.

Referring to FIG. 6, the automatic music generation device 100 according to the disclosed invention can receive text information from user terminals 200A, 200B, and 200C.

For example, the input text information may include the text of ‘a funky 2 minute and 30-second-long song with an intense and danceable drum beat and a catchy bassline.’

The text information input in this way can be input to the text embedding extraction module 1121 and output as a text embedding vector.

In addition, the text embedding extraction module 1121 extracts music-related information such as instruments, genres, and moods included in the input text information into each embedding vector and uses the extracted embedding vectors to search and select sound sources and compose songs.

Additionally, the automatic music generation device 100 according to the disclosed invention can receive image information from the user terminals 200A, 200B, and 200C.

The input image information may be converted into text by the image captioning module 1111 and output as image text information.

For example, the output image text information may include the text ‘Night city view with several buildings and several cars on the street.’

The image text information generated in this way can be input to the text embedding extraction module 1121 and output as a text embedding vector.

Additionally, the automatic music generation device 100 according to the disclosed invention can receive video information from the user terminals 200A, 200B, and 200C.

The input video information may be converted into text by the video captioning module 1113 and output as video text information.

Additionally, the automatic music generation device 100 according to the disclosed invention can receive music information from the user terminals 200A, 200B, and 200C.

The input music information may be converted into text by the music captioning module 1112 and output as music text information.

For example, the output music text information is ‘lively and energetic, the tempo of the guitar riff is fast’ may be included.

The music text information generated in this way can be input to the text embedding extraction module 1121 and output as a text embedding vector.

In addition, the automatic music generation device 100 according to the disclosed invention generates and outputs a music embedding vector through the music embedding extraction module 1122 from the music information input from the user terminals 200A, 200B, and 200C, chord progression embedding vector through the chord progression embedding extraction module 1123, and a frequency band embedding vector through the frequency band embedding extraction module 1124.

The text embedding vector, music embedding vector, chord progression embedding vector, and frequency band embedding vector output in this way may be collectively referred to as an input embedding vector, and the input embedding vector may be input to the stem search module 113.

Afterwards, the automatic music generation device 100 according to the disclosed invention can select a reference stem through the stem search module 113, filter a database to determine similarity, and select a similar stem similar with the input information from the filtered database.

Additionally, the automatic music generation device 100 may generate a reference section by editing and mixing selected similar stems and generate music in song units by generating a plurality of similar audio sections based on the reference section.

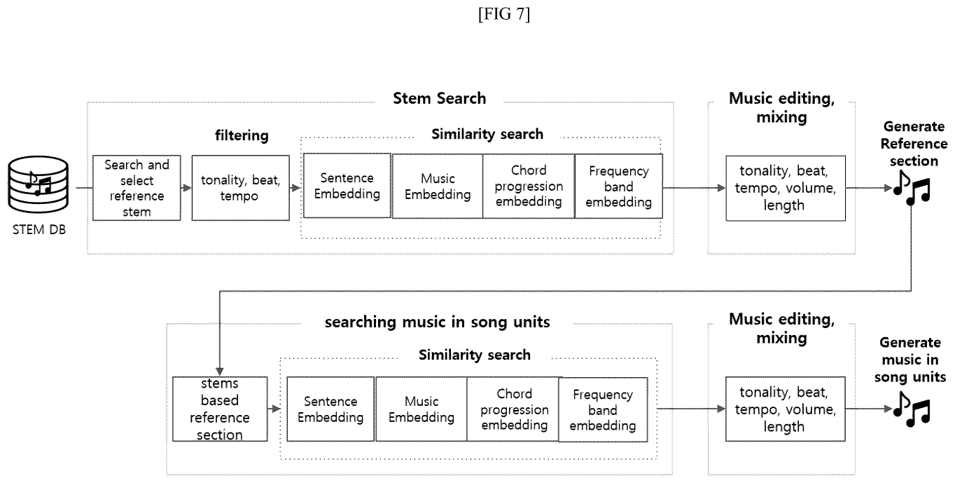

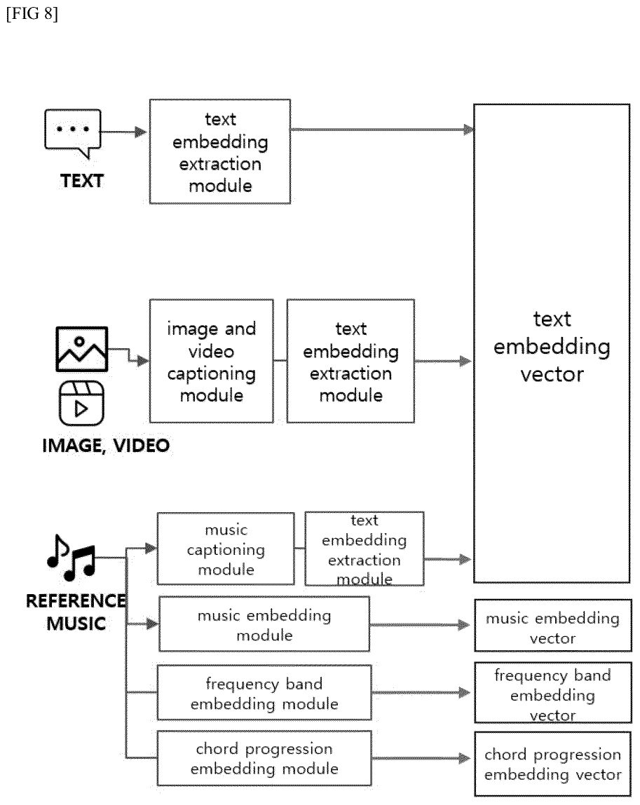

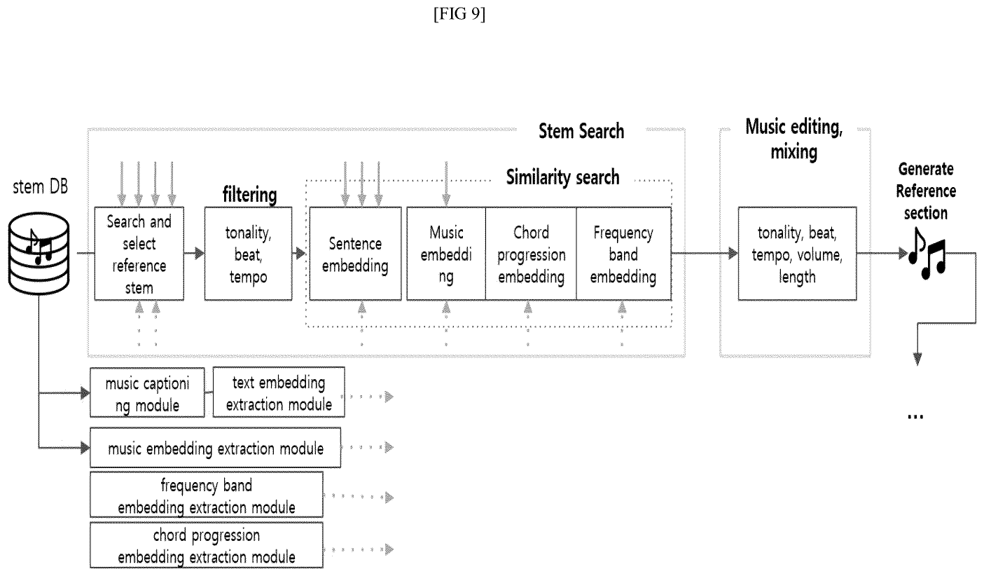

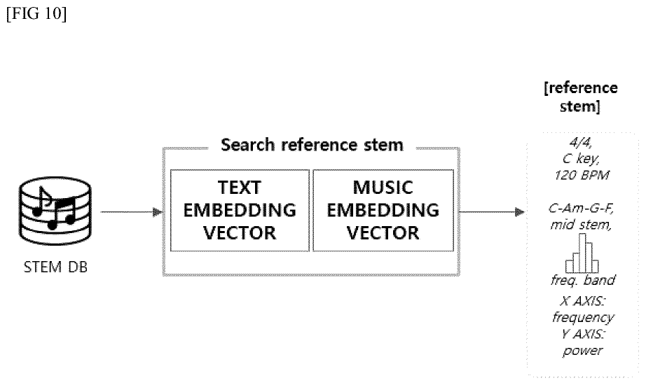

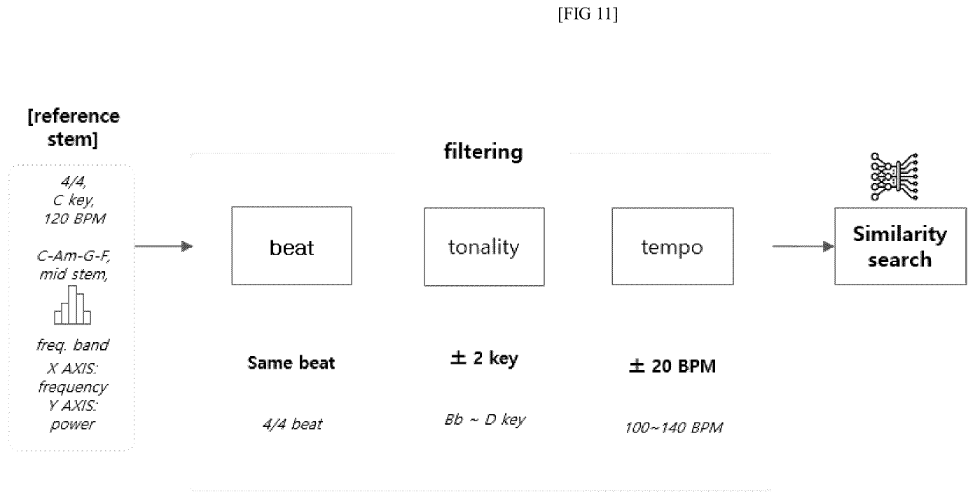

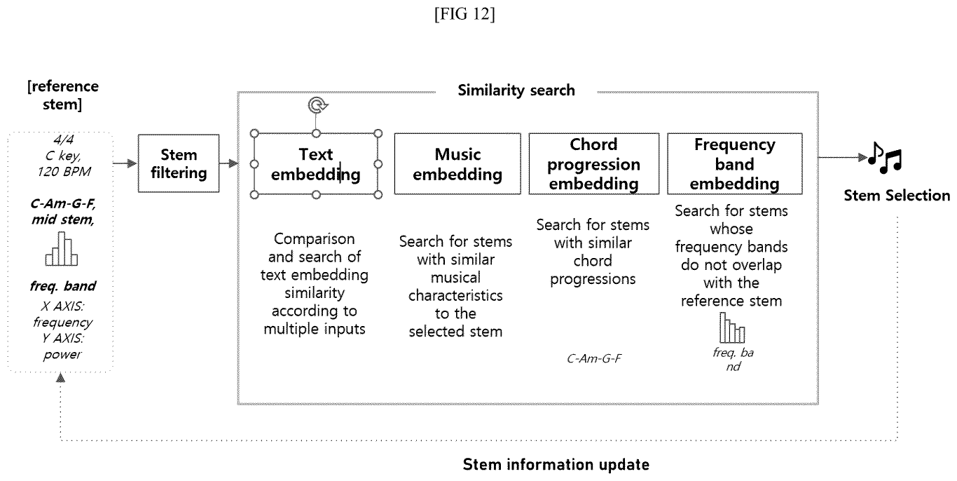

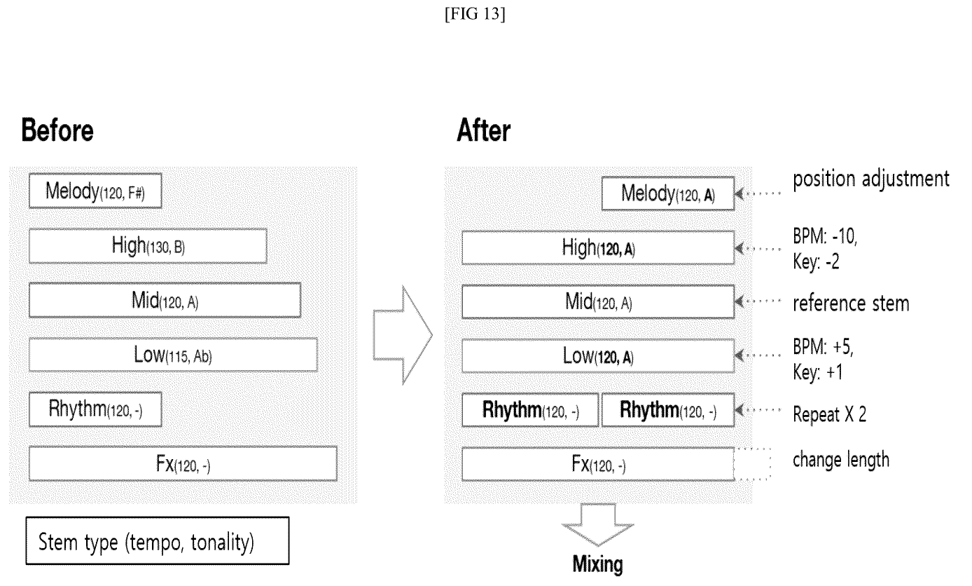

FIG. 7 is a diagram illustrating a process in which a multi-modal-based automatic music generation device according to an embodiment of the disclosed invention generates a stem-based reference section and generates music in song units. FIG. 8 is a diagram illustrating a process in which an input embedding vector is generated by inputting text information, image information, video information, and reference music information into a multi-modal-based automatic music generation device according to an embodiment of the disclosed invention. FIG. 9 is a diagram illustrating the process of generating a reference stem, a similar stem, and a reference section using the input embedding vector shown in FIG. 8. FIG. 10 is a diagram illustrating a process of selecting a reference stem in a multi-modal-based automatic music generation device according to an embodiment of the disclosed invention. FIG. 11 is a diagram illustrating a process of filtering a database based on a reference stem in a multi-modal-based automatic music generation device according to an embodiment of the disclosed invention. FIG. 12 is a diagram illustrating a process of selecting a similar stem from a filtered database in a multi-modal-based automatic music generation device according to an embodiment of the disclosed invention. FIG. 13 is a diagram illustrating a process of creating a reference section by editing and mixing selected similar stems in a multi-modal-based automatic music generation device according to an embodiment of the disclosed invention.

Referring to FIG. 7 and FIG. 8, the automatic music generation device 100 of the disclosed invention inputs text information input through the user terminals 200A, 200B, and 200C into the text embedding extraction module 1121 to generate a text embedding vector.

In addition, the disclosed invention converts image information input through the user terminals 200A, 200B, and 200C into text through the image captioning module 1111 and inputs the converted text information into the text embedding extraction module 1121 to create a text embedding vector.

In addition, the disclosed invention converts reference music information input through the user terminals 200A, 200B, and 200C into text through the music captioning module 1112 and inputs the converted text information into the text embedding extraction module 1121 to create a text embedding vector.

In addition, the disclosed invention converts video information input through the user terminals 200A, 200B, and 200C into text through the video captioning module 1113 and inputs the converted text information into the text embedding extraction module 1121 to create a text embedding vector.

In addition, the disclosed invention generates a music embedding vector through the music embedding extraction module 1122 from reference music information input through the user terminal 200A, 200B, 200C, frequency band embedding vector through the frequency band embedding extraction module 1124 and chord progression embedding vector through the chord progression embedding extraction module 1123.

The various input embedding vectors generated in this way can be used in the stem search process, which will be described later.

Referring to FIGS. 7 and 9, the automatic music generation device 100 of the disclosed invention determines the similarity between the text embedding vector and music embedding vector included in the input embedding vector and the text embedding vector and music embedding vector of the stem included in the stem database to search and select the reference stem.

At this time, the music captioning module 1112, the music embedding extraction module 1122, the frequency band embedding extraction module 1124, and the chord progression embedding extraction module 1123 of the disclosed invention can also be used to extract the embedding vector of the stem included in the stem database.

Thereafter, the automatic music generation device 100 of the disclosed invention may filter the stem database based on the tonality, beat, and tempo information of the reference stem.

Thereafter, the automatic music generation device 100 of the disclosed invention may determine the similarity between the text embedding vector included in the input embedding vector and the text embedding vector of the stem included in the filtered database.

Additionally, the automatic music generation device 100 of the disclosed invention can determine the similarity between the music embedding vector included in the input embedding vector and the music embedding vector of the stem included in the filtered database.

In addition, the automatic music generation device 100 of the disclosed invention can determine the similarity between the chord progression embedding vector of the reference stem and the chord progression embedding vector of the stem included in the filtered database.

Additionally, the automatic music generation device 100 of the disclosed invention can determine the similarity between the frequency band embedding vector of the reference stem and the frequency band embedding vector of the stem included in the filtered database.

At this time, the disclosed invention can select a plurality of similar stems whose frequency bands do not overlap with the reference stem and whose frequency bands do not overlap with each other, based on the frequency band embedding vector of the reference stem.

Additionally, the disclosed invention can create reference sections by editing and mixing the tonality, beat, tempo, volume, and length of selected similar stems.

Hereinafter, a step that the automatic music generation device 100 according to the disclosed invention searches and selects a reference stem, filters the database based on the reference stem, and selects similar stems from the stems included in the filtered database for editing and mixing will be explained.

Referring to FIGS. 10 to 13, the reference stem selection module 1131 according to the disclosed invention may search and select a reference stem from a stem database based on the text embedding vector and music embedding vector included in the input embedding vector.

At this time, the reference stem may have an embedding vector including beat, tonality, tempo, chord progression, and frequency band information.

Thereafter, as shown in FIG. 11, the filtering module 1132 may filter the stem database based on the embedding vector including the beat, tonality, and tempo information of the reference stem.

More specifically, the filtering module 1132 filters stems having the same beat information as the beat information of the reference stem, filters stems having tonality information within 2 Keys of the tonality information of the reference stem and filters stems with tempo information within 20 BPM of the tempo information of the reference stem and configures the database.

Thereafter, as shown in FIG. 12, the similar stem selection module 1133 may determine the degree of similarity with the input embedding vector for the stem database filtered by the filtering module 1132.

More specifically, the similar stem selection module 1133 determines the similarity between the text embedding vector included in the input embedding vector and the text embedding vector of the stem in the filtered database and assigns a score to each stem in order of high similarity.

In addition, the similar stem selection module 1133 determines the similarity between the music embedding vector included in the input embedding vector and the music embedding vector included in the reference stem and the music embedding vector of the stem in the filtered database and ranks them in descending order of similarity.

In addition, the similar stem selection module 1133 may determine the similarity between the chord progression embedding vector included in the reference stem and the chord progression embedding vector of the stem in the filtered database and assign a score to each stem in order of high similarity.

In addition, the similar stem selection module 1133 may determine the similarity between the frequency band embedding vector included in the reference stem and the frequency band embedding vector of the stem in the filtered database and assign a score to each stem in descending order of similarity.

This is to create a harmonious reference section without interference between stems by selecting stems whose frequency bands do not overlap with the reference stem as similar stems.

Additionally, the automatic music generation device 100 according to the disclosed invention can select the most optimal similar stem by repeating the process of feeding back information about the selected similar stem to the reference stem.

Additionally, as shown in FIG. 13, the reference section generation module 114 of the disclosed invention may generate a reference section by editing and mixing selected similar stems.

More specifically, the reference section may include a plurality of stems whose frequency bands do not overlap with each other.

Multiple stems refer to data for a single item constituting a sound source. For example, types of stems may include rhythm stems, bass stems, mid stems, high stems, FX stems, and melody stems.

In addition, the reference section generation module 114 performs editing such as adjusting the position of a plurality of stems, adjusting the tempo, adjusting the tonality, or adjusting the length, and mixes the plurality of edited stems to create a reference section.

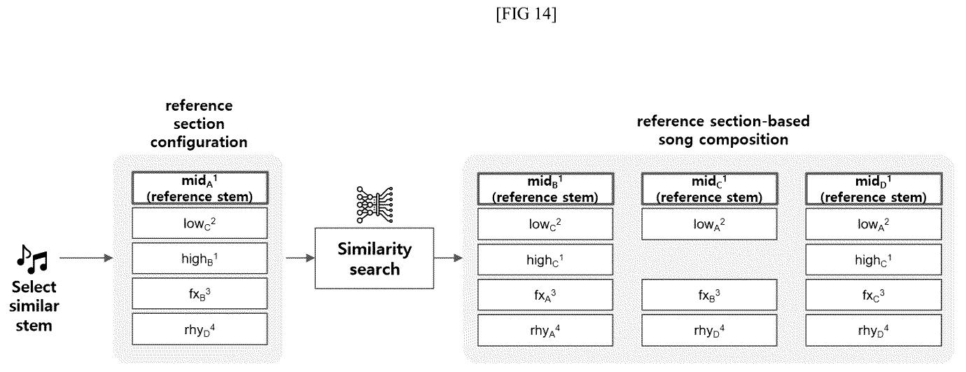

FIG. 14 is a diagram illustrating a process of generating music in song units based on a reference section in a multi-modal-based automatic music generation device according to an embodiment of the disclosed invention.

Referring to FIG. 14, the reference section may include a reference stem corresponding to a mid-stem and a plurality of similar stems including a plurality of stems selected by the similar stem selection module 1133.

However, the reference stem does not always consist of a Mid stem, and the reference stem may consist of other stems such as a Low stem or a High stem.

For example, the reference section may consist of Rhythm stem, Low stem, Mid stem, High stem, and FX stem.

The music generation module 115 of the disclosed invention can generate a plurality of audio sections similar with the reference section.

For example, a plurality of audio sections generated by the music generation module 115 may also be composed of a rhythm stem, low stem, mid stem, high stem, and FX stem.

Additionally, each audio section may not include all Rhythm stems, Low stems, Mid stems, High stems, and FX stems.

The music generation module 115 of the disclosed invention may select the mid stem of the original sound source including the reference stem of the reference section as the reference stem of each audio section.

At this time, the music generation module 115 may sequentially place mid stems in each audio section in the order of progression of the original song sound source, or regardless of this, mid stems may be placed in a free order considering the progression of the song.

The mid stem arranged in this way can serve as a reference stem for each audio section.

Afterwards, the music generation module 115 of the disclosed invention determines the reference stem of a single audio section, and then selects the Rhythm stem, Low stem, High stem, and FX stem except for the Mid stem. Each can be selected from the sound source by judging its similarity to the reference stem of the corresponding audio section.

At this time, each stem of each audio section consists of a stem extracted from the original song including each stem of the reference section.

For example, as shown in FIG. 14, the low stem of the reference stem is a stem included in song No. 2, so the low stems of the plurality of audio sections created based on this are each audio section. The similarity with the reference stem is judged, but all can be composed of the stems included in song number 2.

Additionally, since the high stem of the reference stem is a stem included in song No. 1, the high stems of a plurality of audio sections may be composed of stems included in song No. 1.

If there is no stem similar with the reference stem of the corresponding audio section among the stems included in song No. 1, the audio section may be configured without a high stem, as shown in FIG. 14.

Through this, the disclosed invention has the technical effect of creating more natural and high-quality music by reusing the stems that make up each original song to create mixed music.

In addition, the music generation module 115 of the disclosed invention can arrange reverberation so that music between a plurality of section audio can be naturally connected.

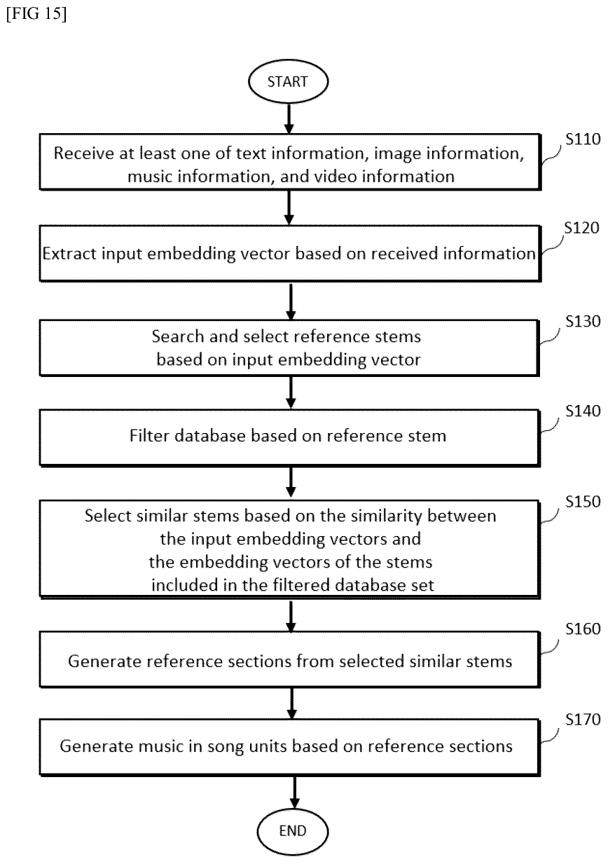

FIG. 15 is a flow chart illustrating a multi-modal-based automatic music generation method according to an embodiment of the disclosed invention.

Referring to FIG. 15, the multi-modal-based automatic music generation method according to an embodiment of the disclosed invention may include receiving at least one of text information, image information, music information, and video information (S110).

Thereafter, the multi-modal-based automatic music generation method according to an embodiment of the disclosed invention may include extracting an input embedding vector based on the received information (S120).

More specifically, the step of extracting the input embedding vector (S120) includes generating a text embedding vector from text information, converting image information, video information, and music information into text to generate a text embedding vector, generating a music embedding vector from music information, generating a chord progression embedding vector from music information, and generating a frequency band embedding vector from music information.

Thereafter, the multi-modal-based automatic music generation method according to an embodiment of the disclosed invention may include a step of searching and selecting a reference stem based on the input embedding vector (S130).

Thereafter, the multi-modal-based automatic music generation method according to an embodiment of the disclosed invention may include filtering the database based on the reference stem (S140).

Thereafter, the multi-modal-based automatic music generation method according to an embodiment of the disclosed invention includes a step of selecting a similar stem based on the similarity between the input embedding vector and the embedding vector of the stem included in the filtered database set (S150).

Thereafter, the multi-modal-based automatic music generation method according to an embodiment of the disclosed invention may include the step of generating a reference section from the selected similar stem (S160).

Thereafter, the method for automatically generating music based on multi-modal according to an embodiment of the disclosed invention may include the step of generating music in song units based on the reference section (S170).

Therefore, the multi-modal-based automatic music generation method and device according to the disclosed invention generates various types of input embedding vectors from input information including text information, image information, music information, and video information from the user. So, there is an advantage in being able to create song-level music by combining multiple stems from the audio database.

In addition, the method and device for automatically generating multi-modal music according to the disclosed invention generates more natural and complete music by selecting a reference stem from an audio database based on an input embedding vector and then selecting a similar stem through the process.

In addition, the multi-modal-based automatic music generation method and device according to the disclosed invention automatically generates music in a completed song unit that reflects the atmosphere of the text, image, video, and music input from the user, and updates it in the database to provide with sound sources of similar styles and the user can be created and enjoyed the music continuously.

The device described above may be implemented with hardware components, software components, and/or a combination of hardware components and software components. For example, devices and components described in embodiments may include, for example, a processor, a controller, an arithmetic logic unit (ALU), a digital signal processor, a microcomputer, a field programmable array (FPA), It may be implemented using one or more general-purpose or special-purpose computers, such as a programmable logic unit (PLU), microprocessor, or any other device capable of executing and responding to instructions.

A processing device may perform an operating system (OS) and one or more software applications that run on the operating system.

Additionally, a processing device may access, store, manipulate, process, and generate data in response to the execution of software.

For ease of understanding, a single processing device may be described as used, however, those skilled in the art will understand that a processing device includes multiple processing elements and/or multiple types of processing elements.

For example, a processing device may include multiple processors or one processor and one controller.

Additionally, other processing configurations, such as parallel processors, are possible.

Software may include a computer program, chord, instructions, or a combination of one or more of these, which may configure a processing unit to operate as desired or may be processed independently or collectively and command the device.

Software and/or data may be used on any type of machine, component, physical device, virtual equipment, computer storage medium or device to be interpreted by or to provide instructions or data to a processing device.

Software may be distributed over networked computer systems and stored or executed in a distributed manner.

Software and data may be stored on one or more computer-readable recording media.

The method according to the embodiment may be implemented in the form of program instructions that can be executed through various computer means and recorded on a computer-readable medium.

The computer-readable medium may include program instructions, data files, data structures, etc., singly or in combination.

Program instructions recorded on the medium may be specially designed and configured for the embodiment or may be known and available to those skilled in the art of computer software. Examples of computer-readable recording media include magnetic media such as hard disks, floppy disks, and magnetic tapes, optical media such as CD-ROMs and DVDs, and magnetic media such as floptical disks.—Includes optical media (magneto-optical media) and hardware devices specifically configured to store and execute program instructions, such as ROM, RAM, flash memory, etc.

Examples of program instructions include machine language chord, such as that produced by a compiler, as well as high-level language chord that can be executed by a computer using an interpreter, etc.

As described above, although the embodiments have been described with limited examples and drawings, various modifications and variations can be made by those skilled in the art from the above description.

For example, the described techniques are performed in a different order than the described method, and/or components of the described system, structure, device, circuit, etc. are combined or combined in a different form than the described method, or other components are used. Alternatively, appropriate results may be achieved even if substituted or substituted by an equivalent.

Therefore, other implementations, other embodiments, and equivalents of the claims also fall within the scope of the claims described below.

1. A multi-modal based automatic music generation device comprising:
an embedding extraction module configured to generate an input embedding vector from input information received from a user terminal;
a stem search module configured to select a reference stem based on the input embedding vector and select a plurality of similar stems based on the input embedding vector and an embedding vector included in the reference stem;
a reference section generation module configured to create a reference section by editing and mixing the plurality of similar stems; and
a music generation module configured to generate music in song units by generating a plurality of audio sections based on the reference section.

2. The multi-modal based automatic music generation device according to claim 1,
wherein the input information includes at least one of text information, image information, music information, and video information.

3. The multi-modal based automatic music generation device according to claim 2, further comprising:
an image captioning module that converts the image information into text and outputs it as image text information;
an video captioning module that converts the video information into text and outputs it as video text information; and
a music captioning module that converts the music information into text and outputs it as music text information.

4. The multi-modal based automatic music generation device according to claim 3,
wherein the embedding extraction module comprising
a text embedding extraction module configured to generate a text embedding vector from the input text information, the image text information, the video text information, and the music text information.

5. The multi-modal based automatic music generation device according to claim 1,
wherein the embedding vector included in the reference stem includes at least one of beat, tonality, and tempo information.

6. A multi-modal based automatic music generation method comprising:
a step of generating an input embedding vector from input information received from a user terminal;
a step of selecting a reference stem based on the input embedding vector and selecting a plurality of similar stems based on the input embedding vector and embedding vectors included in the reference stem;
a step of generating a reference section by editing and mixing the plurality of similar stems; and
a step of generating music in song units by creating a plurality of audio sections based on the reference section.

7. The multi-modal based automatic music generation method according to claim 6,
wherein the input information includes at least one of text information, image information, music information, and video information.
